(19) United States
(12) Patent Application Publication
(10) Pub. No.: US 2011/0092159 A1
(43) Pub. Date: Apr. 21, 2011

(54) DISABLING OF SERVICES ON A COMMUNICATION DEVICE

(75) Inventors: Robert Park, Poway, CA (US); Chris Rodewald, San Diego, CA (US); Tod D. Boretto, Poway, CA (US); Joel Hartley, Solana Beach, CA (US)

(73) Assignee: CellShield, Inc., Encintas, CA (US)

(21) Appl. No.: 12/905,942

(22) Filed: Oct. 15, 2010

Related U.S. Application Data
(60) Provisional application No. 61/252,604, filed on Oct. 16, 2009.

(51) Int. Cl. H04B 7/00

(52) U.S. Cl. 455/41.2

(57) ABSTRACT

A method, a system, and a computer program product for operating a communication device. A location information of a communication device is received. Based on the location information of the communication device, it is determined whether the communication device and another communication device are co-located. Based on the determination, operation of the communication device is controlled.

### CROSS-REFERENCE TO RELATED APPLICATIONS

The present application claims priority to U.S. Provisional Patent Application No. 61/252,604 to Boretto et al., filed Oct. 16, 2009, and entitled “Selective Portable Communication Device Service Disabling,” the disclosure of which is incorporated herein by reference in its entirety.

### TECHNICAL FIELD

The subject matter described herein generally relates to restricting services of a communication device. Some implementations of the subject matter relate to selectively disabling services provided by an individual's communication device based on a location of the communication device or other determination that the individual is engaged in an activity for which the distractions of the communication device usage can be dangerous or should otherwise be restricted.

### BACKGROUND

Cell phone and other portable communication device usage while driving has been determined through numerous independent studies to significantly impair a vehicle operator's ability to drive or operate vehicles including private vehicles, public transportation, automobiles, and heavy equipment. In fact, some studies have definitively determined that the distraction of sending and receiving text messages, e-mail messages, or the like by a driver while operating a vehicle can be even more dangerous than a driver under the influence of alcohol. In response to this public threat, many governments have recently passed legislation aimed at limiting or even eliminating the use of portable communication devices by drivers while operating vehicles. However, there can be instances in which access to a portable communication device can be a life saving tool due to the lack of communications infrastructure in times of a vehicle emergency. Therefore, the selective disabling of specific portable communication device capabilities, such as texting, or one or more specified features, while operating a vehicle can be an advantageous method of controlling operator usage and improving safe vehicle operation. Legislative solutions only address the penalty applied to a user when found guilty of the action and do very little to prevent the effects of this extremely dangerous and in some cases even deadly activity.

### SUMMARY

In some implementations, the current subject matter relates to a computer-implemented method. The method includes receiving a location information of a communication device, based on the location information of the communication device, determining whether the communication device and another communication device are co-located, and based on the determination, controlling operation of the communication device.

In some implementations, the current subject matter relates to a computer program product comprising a machine-readable medium storing instructions that, when executed by at least one processor, cause the at least one processor to perform the following operations: receiving a location information of the communication device, based on the location information of the communication device, determining whether the communication device and another communication device are co-located, and based on the determination, controlling operation of the communication device.

In some implementations, the current subject matter relates to a system including a communication device, another communication device communicatively coupled to the communication device and configured to receiver a location information of the communication device, a server configured to be communicatively coupled to the another communication device and provide communications between the communication device and a communication services provider for the communication device. At least one of the another communication device and the server is configured to determine whether the communication device and another communication device are co-located based on the location information of the communication device and control operation of the communication device based on the determination. At least one service provided by the communication device is configured to be selectively disabled upon determining that the communication device and the another communication device are co-located. All services provided by the communication device are configured to be enabled upon determining that the communication device and the another communication device are no longer co-located.

In some implementations, the current subject matter relates to a system including a processor coupled to a memory and configured to receive a location information of a communication device, based on the location information of the communication device, determine whether the communication device and another communication device are co-located, and based on the determination, control operation of the communication device.

The details of one or more variations of the subject matter described herein are set forth in the accompanying drawings and the description below. Other features and advantages of the subject matter described herein will be apparent from the description and drawings, and from the claims. Articles are also described that comprise a tangibly embodied machine-readable medium operable to cause one or more machines (e.g., computers, etc.) to result in operations described herein. Similarly, computer systems are also described that may include a processor and a memory coupled to the processor. The memory may include one or more programs that cause the processor to perform one or more of the operations described herein.

### BRIEF DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 illustrates an exemplary system for operating a communication device;

FIG. 2 illustrates another exemplary system for operating a communication device in a moving environment;

FIG. 3 illustrates another exemplary system for operating a communication device in a stationary environment;

FIG. 4 illustrates an exemplary co-location in a fixed physical location;

FIG. 5 is a flow chart illustrating an exemplary method for operating a communication device in a moving environment using a location tracking technique;

FIG. 6 is a flow chart illustrating an exemplary searching technique implemented by the method shown in FIG. 5;

FIG. 7 is a flow chart illustrating an exemplary method for operating a communication device in a moving environment using a short-range wireless technique;

FIG. 8 is a flow chart illustrating an exemplary searching technique implemented by the method shown in FIG. 7;

FIG. 9 is a flow chart illustrating an exemplary method for operating a communication device in a moving environment using a location tracking technique and/or short range wireless technique;

FIG. 10 is a flow chart illustrating an exemplary method for operating a communication device in a stationary environment using a location tracking technique;

FIG. 11 is a flow chart illustrating an exemplary method for operating a communication device in a stationary environment using a short-range wireless technique;

FIG. 12 is a flow chart illustrating an exemplary method for operating a communication device in a stationary environment using a location tracking technique and/or short range wireless technique;

FIG. 13 is a flow chart illustrating a method for operating a communication device when the communication device is the only device available for determining its location; and

FIG. 14 illustrates an exemplary system for disabling of services of a communication device.

When practical, similar reference numbers denote similar structures, features, or elements.

### DETAILED DESCRIPTION

To address the above-noted and potentially other issues with currently available solutions, one or more implementations of the current subject matter provide methods, systems, articles or manufacture, and the like that can, among other possible advantages, provide systems and methods for disabling operation of various services on an individual's communication device.

The current subject matter can negate operations of various levels of communication device(s)' capabilities while an individual is operating a specific motor vehicle, in a fixed location or geofence, or while operating machinery. Because the technology is selective certain positive aspects of a communication device can be selectively enabled, such as for example, cellular phone usage for emergency calls. In some implementations, the current subject matter provides a restricted use environment where services provided by the communication device can be restricted in a particular environment or setting so as to alleviate user distractions typically associated with the use of the communication device. For example, it may be desired to disable certain services provided by a communication device (e.g., cellular telephone) of a driver of a vehicle while the vehicle is in motion. Most communication devices (e.g., cellular telephones) provide various services including various applications (e.g., in case of a cellular telephone, making/receiving calls, text messaging, multi-media applications, etc.) that may be distractive to a user of the device in certain environment(s). A restricted use communication device (e.g., a communication device with certain services being disabled) prevents such distractions, thereby increasing efficiency and responsiveness of the user as well as overall safety. In some implementations, it may be desired to enable some services and/or applications provided by the communication device while other services/applications are disabled, where such enabling of services/applications can be done in such a way so as to create a minimal distraction mode on the restricted use environment device (i.e., a communication device having services disabled). The enabled services/applications can have a customized operational capability so as to provide minimum distraction while providing the user with maximum service/application capabilities. Such customization can be done on per user, per service/application, and/or per environment basis. For example, a driver of a vehicle can receive text messages on his/her cellular telephone while driving, where such messages would be read out loud to the driver instead of the driver looking at the screen of his/her cellular telephone to read the message. Other examples include, but are not limited to, voice alerts, text translation to audio, one button calling using hands free communication, simple screens with yes/no options, or any others. As can be understood by one having ordinary skill in the relevant art, the current subject matter is not limited to any of the above customized service(s)/application(s). Further, service(s)/application(s) can be developed and implemented for particular user(s) and/or environment(s). Table below illustrates an exemplary minimal distraction mode of a cellular telephone in a restricted use environment of driving a vehicle:

| | | | Minimal |
|---|---|---|---|
| | Non-restricted | | Distraction |
| Service | Setting | Default Setting | Mode Setting |
| 911 Emergency Calls | Allow | Allow | Allow |
| Incoming Voice Calls | Allow | Disable | Handsfree only |
| Incoming Text | Allow | Disable | Read to driver |
| Messages | | | |
| Incoming Email | Allow | Disable | Read to driver |
| Incoming Voice Mail | Allow | Disable | Read to driver |
| Outgoing Voice calls | Allow | Disable | One Touch |
| | | | Numbers Only |
| Outgoing Text | Allow | Disable | Disable (cannot |
| Messages | | | enable) |
| Outgoing Email | Allow | Disable | Disable (cannot |
| | | | enable) |
| Web Browsing | Allow | Disable | Disable (cannot |
| | | | enable) |

As shown above, each of the services provided by the driver's cellular telephone can be enabled in a non-restricted setting, i.e., when the driver is not engaged in the driving of the vehicle. However, in the restricted use environment, i.e., when the driver is driving, the default setting disables all services but the 911-emergency calling, as the latter cannot be disabled by law. In the minimal distraction mode, certain services can be completely disabled, e.g., sending text messages, email, and web browsing, while incoming text messages, emails, and voice mail can be read out loud to the driver; receiving calls can be possible through handsfree feature only; making calls can be possible through one touch dialing (e.g., the vehicle may include an interface that has a button assigned to a particular name and number, which upon pressing will dial the selected number). As can be understood by one having ordinary skill in the relevant art, the above discussion is provided for exemplary, non-limiting purposes, and the use of minimal distraction mode can be implemented in any environment(s) and/or on any communication device(s) and/or for any user(s).

The current subject matter described herein provides many advantages. For example, in the area of public transportation of any sort, the driver/operators of a vehicle would not be tempted by sending or receiving of text or e-mail messages, surfing the web, or the like since those particular services for a specific communication device can be specifically targeted and suspended. This can eliminate the action which has been attributed to countless accidents and even several documented deaths. Although legislation has been enacted to deter this type of usage and in many cases there may even be organizational prohibition from bringing and using personal cell phones to the job, there is still a common propensity for individuals to keep their communication devices with them due to the ubiquitous nature that such devices have taken on in the modern society.

The applicability of the current subject matter spans across many different areas. One of the areas of significant impact is in the public transportation industry where several fatalities have been linked to the use of text or e-mail messaging by vehicle operators; specifically buses, trains, and subways. Fleet operators and taxi companies can also benefit from their ability to restrict cell phone usage by their employees. On the individual level, the current subject matter can be applied to restrict the use of communication devices by teenage drivers, which can result in prevention of teen deaths in automobiles, the highest cause of youth deaths in America. A broad market may exist among parents interested in removing from their teenagers or other young drivers the temptation to interact with their cell phones or other communication devices while driving. The commercial benefits of the current subject matter can extend beyond improving the safe driving habits of their operators and can potentially also include decreasing fiscal liabilities that emerge from accidents which could be prevented.

The features of the current subject matter pertaining to active restriction of specific capabilities of communication devices can have many secondary and tertiary benefits as well. Costs of operation of private, commercial, and public vehicles can be reduced due to less accidents and deaths. Insurance rates can be reduced based on the implementation and successful application of the current subject matter and public safety can be greatly enhanced due to physical prohibition of an activity that can have potentially deadly consequences. Even personal productivity can be enhanced due to the lack of distractions presented by cellular devices and other communication devices.

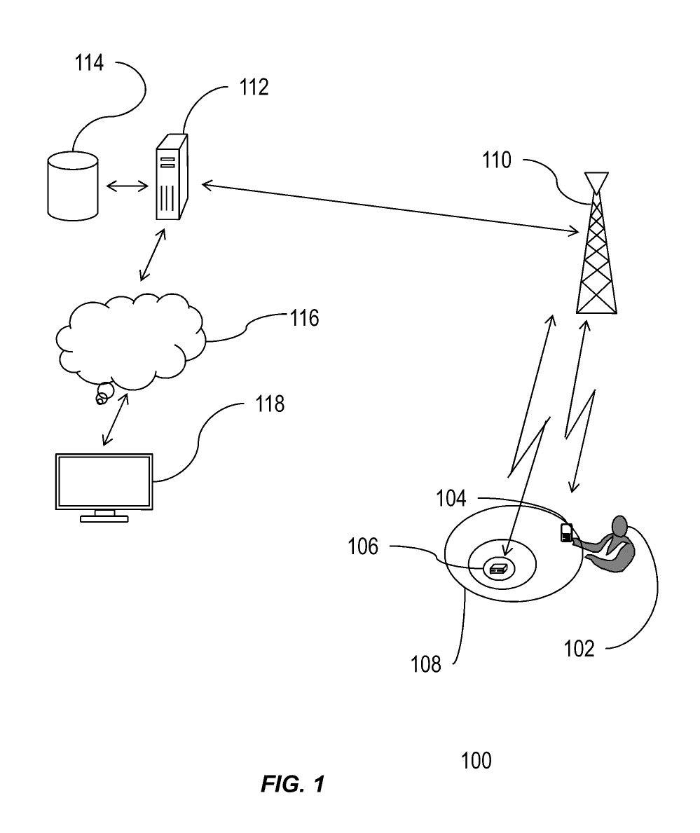

FIG. 1 illustrates an exemplary system 100 for operating a communication device 104, according to some implementations of the current subject matter. System 100 can include a user 102, a communication device 104, another communication device 106 having a co-location area or range 108, communication services provider or carrier network 110, a third communication device or a server 112, a database 114, a network 116, and a user interface 118. The user 102 can be an individual, a business, or any other entity capable of operating the communication device 104. The user 102 can use the communication device 104 for any communication purposes. The communication device 104 can be a telephone, a mobile telephone, a personal computer, a portable computer, a laptop, a facsimile device, a personal digital assistant (“PDA”), iPod, iPad, iPhone, a BLACKBERRY® device, a smartphone, a two way pager, a wireless mobile radio, any type of portable electronic device that allows the user to communicate remotely with another person or device, or any other communication device. The communication device 104 can communicate with the communication services provider network 110, which in turn can communicate with the server 112. As can be understood by one having ordinary skill in the relevant art, the server 112 can be any communication device, such as, a computer network device, a device that is similar to the communication device 104, or any other suitable device. The server 112 can communicate with the interface 118 through network 116 and store information in the database 114. The network 116 can be any wired, wireline, wireless, a two way pager network, cellular telephone network, wireless mobile radio network, Wi-Fi network, Local Area Network (“LAN”), Wide Area Network (“WAN”), Metropolitan Area Network (“MAN”), or any other suitable network. In some implementations, the interface 118 can include a graphical user interface, which can be used to control operation of the communication device 104 through the server 112 and the services provider network 110. The services provider network 110 can be any wireless, wireline or wired network, a two way pager network, cellular telephone network, wireless mobile radio network, Wi-Fi network, WAN, MAN, LAN, or any other suitable network. As can be understood by one having ordinary skill in the relevant art, the communication device 104, services provider network 110, the server 112, and the interface 118 can be communicatively coupled to one another using any of the above identified ways, networks, devices, etc.

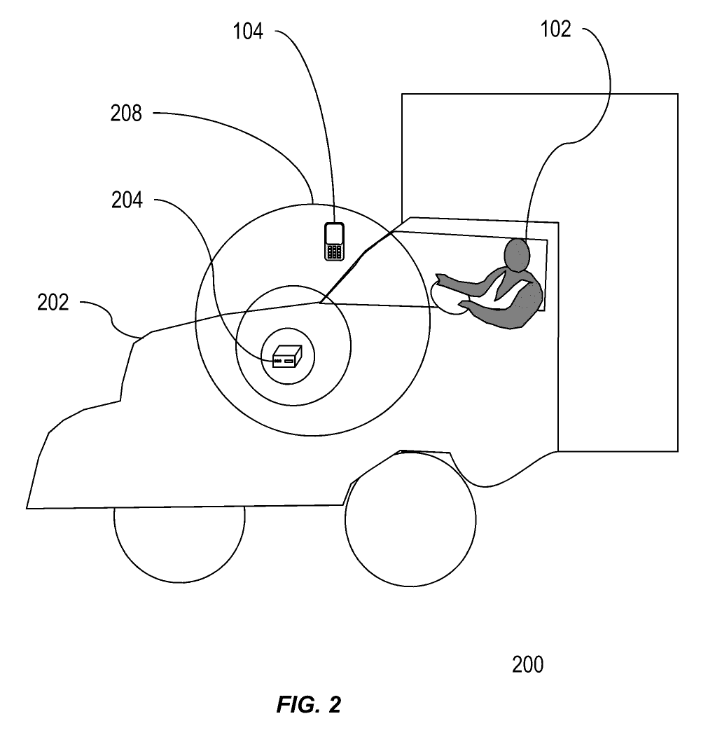

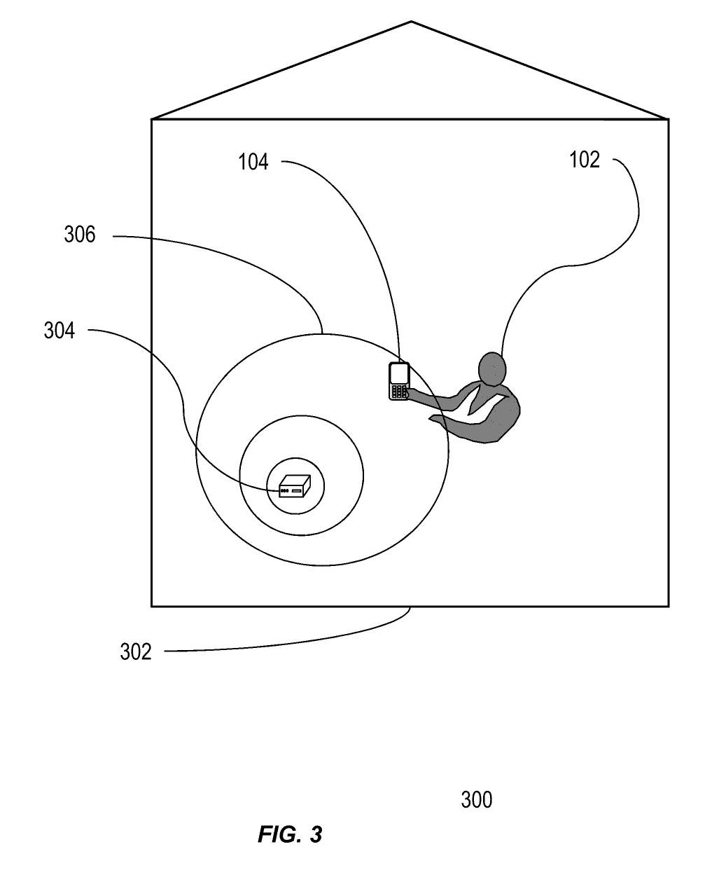

The communication device 104 can be operated by the user 102 in various environments, e.g., to make a wireless telephone call using a cellular telephone, where the communication device 104 is the cellular telephone. The environments can be a mobile or moving systems (as illustrated in FIG. 2), stationary or fixed systems (as illustrated in FIG. 3), hybrid systems (e.g., mobile/fixed systems), or any other systems. As can be understood by one skilled in the relevant art, the present invention is not limited to the communication device and/or systems identified above.

In some implementations of the current subject matter, communication device 104 can provide various wireless (making/receiving calls, text messaging, short messaging services (“SMS”), multimedia messaging services (“MMS”), email services, voicemail service, emergency calling services, global positioning system (“GPS”) services, Internet browsing, etc.) and/or non-wireless services (photography, video recording, audio recording, word processing, multimedia application services, etc.). In certain situations, it may be desirable to disable at least one or all services on the communication device 104. For example, when the user 102 is driving a vehicle in a capacity of a driver of that vehicle and the communication device 104 is a cellular telephone, the user 102 can be prevented from using his/her cellular telephone, e.g., making/receiving calls, text messaging etc., while the vehicle's ignition is turned on, the vehicle is in motion, etc. User's cellular telephone may be completely disabled, i.e., it cannot be used for any type of service that may be provided by the cellular telephone or, alternatively, some services may be enabled, for example, an ability to make emergency 911 calls. Such selective disabling/enabling of services provided by the communication device 104 can be useful in preventing a teenager from driving and using his/her cellular telephone or other portable communication device. Some implementations of the current subject matter can be useful in preventing an employee in using the communication device 104 for purposes that are not work-related or within the scope of his/her employment (e.g., employee browsing Internet on employee's workstation for matters that are unrelated to employee's job responsibilities).

In some implementations, the server 112 can be a computer network device that can process data from the network 110 and store information in the database 114. There may be one or more servers in the network. The database 114 can store information concerning each user and his/her communication device 104 along with information which services that are provided by the communication device 104 are to be disabled/enabled, at what time, for how long, etc. This information can be communicated to the server 112 from various sources, including another communication device 106, the network 110, another user that may have authority to control usage of the communication device 104 by the user 102 (e.g., parent of a teenager having a cellular telephone, employer of an employee using a personal computer, etc.), an operator that has access to the communications provided by the network 110, a legal authority (e.g., a governmental authority requiring cellular telephones not to be used while driving a vehicle, etc.). In some implementations, the operator may be disposed at the interface 118 and can control disabling/enabling of services on the communication device 104. Such control can be accomplished through issuance of various commands based on the information provided by the server 112 via the network 116. In some implementations, the interface 118 can be used by a dispatcher operating a fleet of vehicles or it may be used by a parent to affect the behavior of their children using communication device 104 in certain locations or during certain times of the day. As can be understood by one having ordinary skill in the relevant art, the current subject matter is not limited to the examples provided above and any appropriately authorized third party (e.g., an individual, a computer, a system, or any other entity) can exercise control over what services are enabled/disabled on the user's communication device. In some implementations, the current subject matter provides an enforceable solution that can provide alerts if the system controlling operation of the communication device is malfunctioning, being tampered with, has failed, interfered with, interrupted, or its operation is changed in a way that is undesired or unexpected.

In some implementations of the current subject matter, such disabling/enabling of services on the communication device 104 can be based on a determination whether the communication device 104 is located within a predetermined co-location range 108 of another communication device 106. Another communication device 106 can be disposed in a vehicle or any other moving or mobile location (as illustrated in FIG. 2) or at a stationary or fixed location (as illustrated in FIG. 3). In some implementations of the current subject matter, another communication device 106 can be any device, such as a communication device, an electronic device, a network device, a server, or any other device. It can be or can be included in, but is not limited to, a Global Positioning System (“GPS”) along with any receiving/transmitting devices and a processing equipment, Wide Area Network (“WAN”) wireless device(s), e.g., a cellular modem, a satellite modem, a pager, Local Area Network (“LAN”) device(s), e.g., wireless LAN, Wi-Fi, Bluetooth, Zigbee, Radio Frequency Identification (“RFID”) device. As can be understood by one having ordinary skill in the relevant art, the subject matter of the present application is not limited to any of the devices listed above and any other suitable device(s) that can be implemented in the system 100. In some implementations of the current subject matter, the system 100 can include a signal jamming device, signal scrambling device, signal scanning, and/or any combination thereof.

The co-location range 108 can be configured to at least partially surround another communication device 106. The co-location range can be configured to be limited to a particular physical or geographical area that can at least partially surround another communication device 106. The co-location range 108 can be defined by a short-range wireless signal that is transmitted by another communication device 106 in any direction and/or in a predetermined direction (e.g., in a vehicle, the signal can be transmitted toward location of the driver of the vehicle), whereby if a communication device receives the transmitted short-range wireless signal, that communication device falls within the co-location range of another communication device 106. In some implementations, the co-location range can be defined by any other means, e.g., radio waves, electromagnetic waves, pulse, light, sound, infrared, or any other ways for detecting devices that are located in the co-location range of another communication device 106. As can be understood by one having ordinary skill in the relevant art, the co-location range 108 can have any shape, form, or size, or any other parameters, which can be predetermined in accordance with particular devices 104, 106, as well as, user 102. The co-location range 108 can be adjustable based on any factors that may be predetermined by various users of the system 100, the system 100 itself, the network 110, or in any other ways. In some implementations where co-location range 108 is defined by a signal, the signal transmitted by another communication device can have varying strength (e.g., stronger signal closer to the device 106 and weaker signal further away from the device 106). This can accommodate situations where the user 102 can use the device 104 while moving away from the co-location range (e.g., in case of in-vehicle systems (FIG. 2), the user 102 can exit the vehicle, while it is parked and running, and make a call). In some implementations, the co-location range can be selectively turned on and off at a predetermined period of time. For example, while the vehicle's ignition is turned on and/or while the vehicle is in motion, another communication device 106 can be activated and the co-location range 108 is enabled, whereby any known or unknown communication devices that fall within the co-location range 108 will have their services appropriately affected, e.g., selectively disabled/enabled. Once such communication devices fall outside the co-location range 108, the services provided by the communication devices can be appropriately restored.

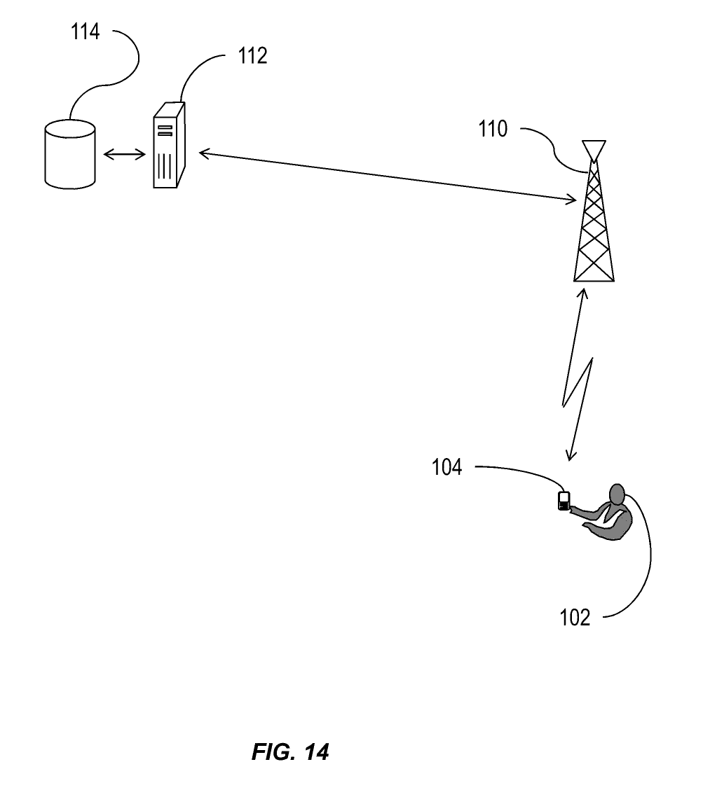

FIG. 14 illustrates exemplary ways of disabling services provided by the communication device 104, according to some implementations of the current subject matter. The communication device 104 can be configured to include an application that is residing on the device 104 and that responds to commands from the server 112, which is communicatively coupled to the communication device 104 via the network 110. The commands can be based on a particular activity performed by the user 102 (e.g., driving a vehicle), a predetermined time, whether the communication device 102 is a known or unknown device with regard to another communication device 106, server 112, etc., prior history of communications between the communication device 102 and another communication device 106, as well as any other parameters that can be predetermined by the user, other users, network, laws, etc. Such parameters can be stored in the database 114 communicatively coupled to the server 112. The application residing on the device 104 can report location of the communication device 102 to the server 112 and based on the location of the device (e.g., whether the device falls within a co-location range of another communication device 106) and/or any other factors, the server 112 and/or another communication device 106 can selectively disable at least one service or all services provided by the device 104. In some implementations, the application on the device 104 can indicate to the user 102 that certain services have been disabled.

In some implementations of the current subject matter, the server 112 can communicate with the network 110 to disable at least one service (e.g., voice and data services) of the communication device 104 in the network 110 itself. This way of affecting operation of the communication device 104 might not require any applications to be installed on the communication device 104. For example, the network 110 can, upon receipt of an appropriate indication from the server 112 and/or another communication device 106 disable at least one service provided by the communication device 104. This is referred to as carrier compliance. For example, in a situation where the communication device belongs to a member of an organization (e.g., driver of a vehicle in a fleet of vehicles), the location of that member's communication device can be determined using various methods (e.g., GPS) and provided by the carrier network providing communication servers to the communication device without installation of separate applications on the member's communication device.

In some implementations, another communication device 106 upon detecting that the communication device 104 is disposed or located within its co-location range 108 can disable at least one service on the device 104 without interaction with the server 112 and/or the network 110. For example, upon turning on a vehicle's ignition, another communication device 106 turns on generating its co-location range 108 and if it detects a cellular telephone 104 falling within the co-location range 108, it effectively disables calling and data services on the cellular telephone 104. This can be useful if immediate disablement of services provided by the communication device 104 is desired.

FIG. 2 illustrates an exemplary moving or mobile system 200 for operating the communication device 104 carried by the user 102. As shown in FIG. 2, the system 200 is disposed within a vehicle 202 and the user 102 is the driver of the vehicle 202. An in-vehicle system 204, which is similar to another communication device 106, is disposed within the vehicle 202. The in-vehicle system 204 has a co-location range 208. Once the device 104 is within the co-location range 208, the device 104 and the system 204 are configured to be co-located. In some implementations of the current subject matter, the system 204 can identify the device 104 upon device 104's entry into the co-location range 208 by sending a signal to the device 104 and waiting for the device 104's response. Upon receiving the response, the system 204 determines that the device 104 is within the co-location range 208. In some implementations, the system 204 can communicate with the server 112 (not shown in FIG. 2) and request exact location of the device 104, whereby upon receiving coordinates of the device 104, the system 204 can determine whether or not the device 104 is within co-location range 208. As can be understood by one having ordinary skill in the relevant art, the current subject matter is not limited to the above-referenced methods of determining whether the device 104 is within a co-location range of another communication device.

As stated above, it may be desirable to disable services on the communication device 104 during a specific period of time in which the driver 102 is engaged with the responsibilities of driving or operating the vehicle 202 under certain conditions. At least one service/capability of the communication device 104 that are selected for disabling can be targeted and turned off during the time of operation of the vehicle and then eventually restored under appropriate conditions. When the communication device 104 is within the co-location range 208, the system 200 can selectively disable at least one service of the communication device 104. Such services can include, but are not limited to, text messaging, access to the internet, voice calls, games, email, web browsing, running applications and the like. These services may be disabled individually leaving one or more other services of the communication device 104 intact and fully operational. Thus, some implementations of the current subject matter can be used to actively enforce laws or regulations restricting the use of portable communication devices within a space or area, for example, the driver's seat of a vehicle, during the conduct of official business, or in any other circumstances. Similar restrictions can be enforced for an individual within the confines of their personal vehicle(s) based on preferences established by an owner or other person or entity with legal authority to control the use of a vehicle. When the services are disabled on the communication device 104, the driver or user 102 is not distracted by the communications device 104. As can be understood by one having ordinary skill in the relevant art, current subject matter is not limited to selectively disabling services of a communication device, e.g., a cellular telephone, in a vehicle, and can be applicable to any moving or mobile environment, where it is desirable to prevent the user 102 from using his/her communication device 104.

FIG. 3 an exemplary stationary or fixed system 300 for operating the communication device 104 carried by the user 102, according to some implementations of the current subject matter. As shown in FIG. 3, the system 300 includes a stationary or fixed location 302, where another communication device or a fixed location system 304 is disposed. The fixed location 302 can be a building, an area of interest, or any other location. Another communication device 304 is similar to devices 106 and 204, shown in FIGS. 1 and 2, and can communicate with another device. Similarly to the devices 106 and 204, the device 304 can include, but is not limited to, GPS receivers, WAN wireless device(s) such as cellular modems, satellite modem(s), and pager(s), LAN device(s), such as Wireless LAN, Wi-Fi, Bluetooth, Zigbee, Radio Frequency Identification (“RFID”) device(s) or the like as well as radio transmitters/receivers that can be used as jamming, scanning, and/or detecting devices.

When the user 102 carries the communication device 104 into the fixed location of interest 302, the fixed location system 304 can determine whether the communication device 104 entered into/is within the co-location range 306 of the system 304. The communication device 104 and the fixed location system 304 are co-located when they are within the co-location range 306. The system 304 can determine whether the device 104 is within its co-location range 306 using similar methods discussed above with regard to FIG. 2.

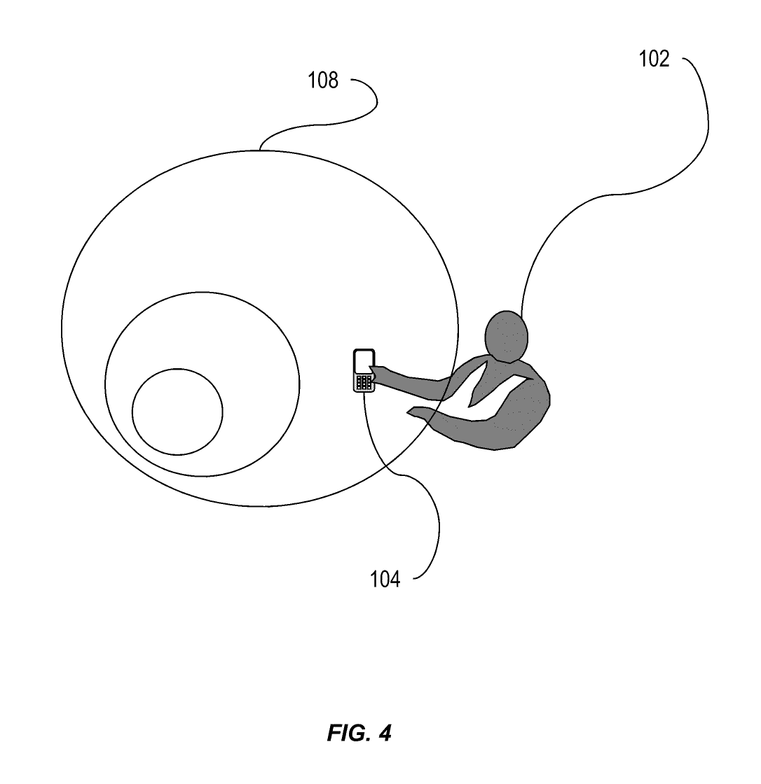

As can be understood by one having ordinary skill in the relevant art, the above discussed concepts are not limited to users of in-vehicle systems 204 or fixed location systems 304. When the user 102 carries the communication device 104 into a region of interest having the co-location range 108, then the communication device 104 is co-located with the specific geographic area. The co-location range 108 can sometimes called a geofence. This is illustrated in FIG. 4, where a communication device 104 is being carried into a geofence 108. The geofence 108 can have any size and/or shape and can also be adjustable. In some implementations, the geofence 108 can exist during a predetermine time period (e.g., when a student-user of the communication device is attending a class in school or doing homework at home, where school and home can be the physical locations, respectively, and as such, provide a geofence). In some implementations, location of the communication device 104 can be determined using coordinates provided by various location systems (e.g., GPS), location tracking signals, or using any other suitable technology. As can be further understood by one having ordinary skill in the relevant art, the present invention is not limited to moving or stationary systems and can be a hybrid system having elements of a moving system and a stationary system.

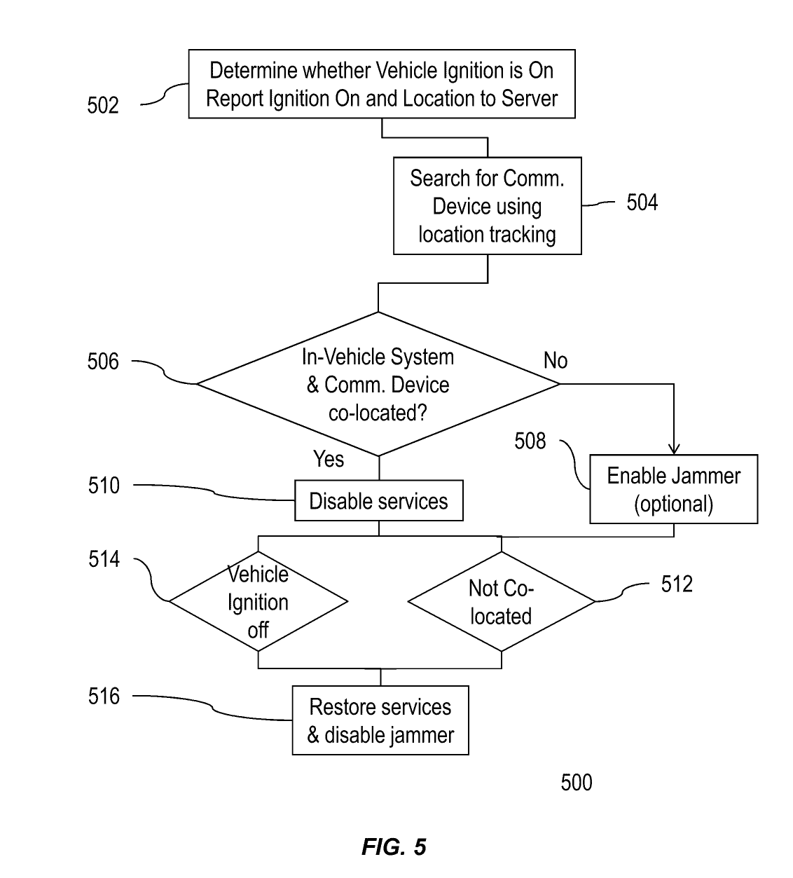

FIGS. 5-13 along with the following discussion illustrate various exemplary methods of selectively disabling at least one service of the communication device 104 in the system 100. For ease of illustration, the following discussion is presented in reference to in-vehicle system 204 (shown in FIG. 2) or the fixed system 304 (shown in FIG. 3) As can be understood by one having ordinary skill in the relevant art, the current subject matter is not limited to the methods and systems described herein and other methods and systems of disabling services are possible.

FIG. 5 illustrates an exemplary method 500 for operating a communication device, according to some implementations of the current subject matter. In particular, method 500 can be used to disable communication services in a vehicle having an in-vehicle system 204 using location tracking. At 502, the in-vehicle system 204 determines whether or not vehicle's ignition has been turned on. Upon detection of the vehicle's ignition “on” status, the in-vehicle system 204 can report the ignition “on” event and location of the vehicle (and thus, the in-vehicle system 204) to the server 112. In some implementations, the in-vehicle system 204 can be activated based on a speed of a vehicle, time, weather conditions (rain, snow, etc.), identity of the driver of the vehicle (e.g., user that had multiple violations of the state cell phone laws, etc.), physical/emotional condition of the driver (e.g., the driver is finishing up working a long shift and may be tired, and as such should not be distracted from driving by use of his/her cell phone) or any other triggers. For example, if a vehicle is travelling at a speed that is higher than a certain predetermined speed threshold, all services provided by the communication device 104 can be disabled; if the vehicle is travelling at a speed that is lower than the above predetermined speed threshold but higher than another predetermined speed threshold, than some services provided by the device 104 can be enabled while others are disabled; if vehicle is travelling at a speed that is lower than the another predetermined speed threshold, then all services provided by the device 104 can be enabled. As can be understood by one having ordinary skill in the relevant art, any number of speed thresholds can be used. As can be further understood by one having ordinary skill in the relevant art, any other triggers or a combination of can be used to prompt such searching. At 504, upon receiving this information from the in-vehicle system 204, the server 112 can search for a communication device 104 that can be carried by the user 102.

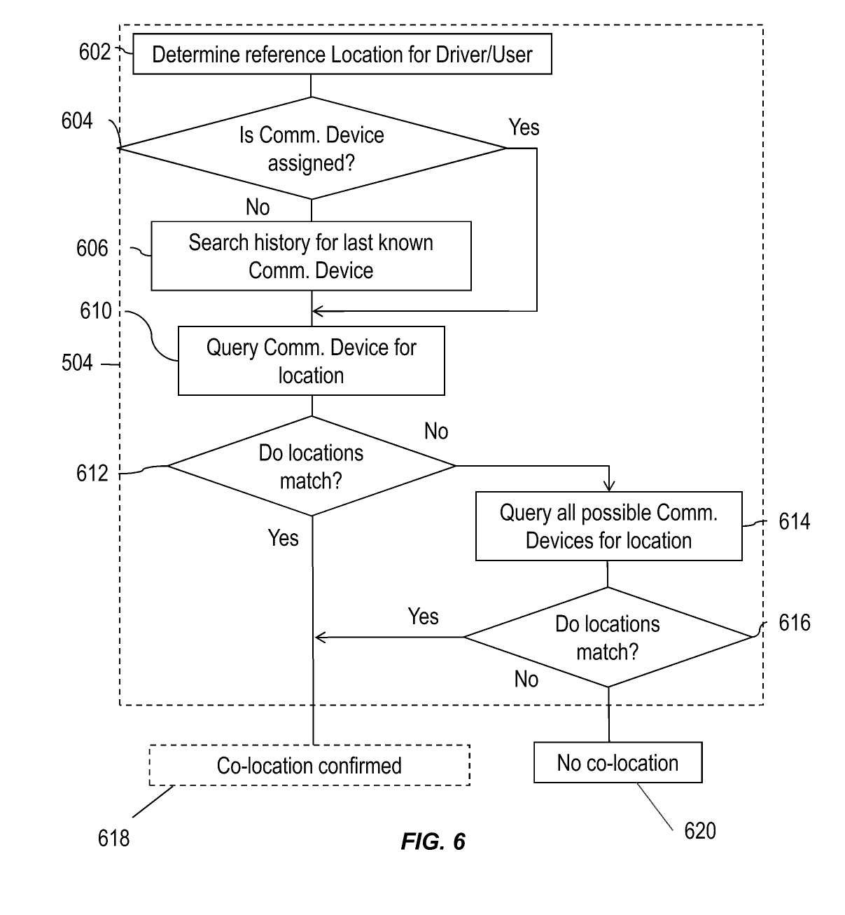

FIG. 6 illustrates further detail of the searching performed by the server 112. At 602, the server 112 determines a location of interest. In some implementations, this can be the same location as the user 102. Alternatively, it can be a fixed location, as in the case of an application where only the communications device 104 exists. Then, the search for a co-located communication device 104 begins. At 604, it is determined whether the communication device 104 has been pre-assigned. If it has been pre-assigned, then at 610, the device 104 is queried for its location. If it has not been pre-assigned, then at 606, the server 112 can search historic records in the database 114 for the last known communications device 104 that can be associated with that location and if such device is found, that device can be queried for its location, at 610. At 612, a determination is made whether either of the determined locations is within the co-location range 108. If so, then a match is found and co-location is confirmed at 618. If no match is found, then, at 614, the server 112 can query all possible communication devices that can be associated with the location determined at 602, to discover which device, if any, in the database 114 is co-located with another communication device 106. At 616, another co-location determination is performed. If match is found, then at 618 a co-location is confirmed. If no match is found, then, at 620, “no co-location” determination is issued and the server 112 can stop further searching.

In some implementations, the query for all possible communication devices can be based on more than location information. Many position location devices not only provide latitude and longitude but other fields of information as well including but not limited to, altitude, velocity, heading, acceleration, and others. Any of these fields can be used to determine co-location of two devices. These fields can be correlated to determine the most likely devices to be co-located.

Referring back to FIG. 5, at 506, a determination is made whether or not the communication device 104 and another communication device 106 (e.g., in-vehicle system 204 or fixed location system 304) are co-located. If not or if no matching communication device is found, then at 508, a jamming device or a jammer, if any, can enabled. The jamming device can be a device that resides in another communication device 106 (e.g., in-vehicle system 204 or fixed location system 304) or, alternatively, it can be a separate device. The jamming device can transmit a radio frequency signal or any other signal in the frequency band of the communication device 104 to interfere with the transmission of signals in that band, thereby blocking communications by the communication device 104. This can effectively disable any communication device 104 in the vicinity of another communication device 106 (e.g., in-vehicle system 204 or fixed location system 304). Otherwise, at 510, if co-location is confirmed, then at least one service to the communication device 104 can be disabled.

Disabling of portable communication device services can be accomplished through local jamming of one or more signals set to and/or from the portable communication device. In some implementations, it can be advantageous to perform the jamming while leaving 911 phone capabilities un-affected, i.e., operational. An accident detection system, device, or feature can be included within or in communication with another communication device 106 (e.g., in-vehicle system 204 or fixed location system 304). In the event of detection of an accident by the accident detection system, device, of feature, the system can automatically default to ceasing all communication device 104 service denial functions. At this point the operator can be free to use all functions of the communication device 104.

At 516, disabled services of the communication device 104 can be restored and the jamming device disabled, if the vehicle's ignition is turned off, at 514, or, at 512, if the communication device 104 and another communication device 106 (e.g., in-vehicle system 204 or fixed location system 304) are no longer co-located. The “ignition off” event can be detected by another communication device 106 (e.g., in-vehicle system 204 or fixed location system 304) and reported to the server 112. Co-location of the communication device 104 and another communication device 106 (e.g., in-vehicle system 204 or fixed location system 304) can be periodically monitored by the server 112, e.g., by periodically requesting updated location information. Upon detecting that the communication device 104 and another communication device 106 are no longer co-located, the server 112 can enable service via communications with the application on the communications device 104, or via communications with the network 110. The jamming device can be disabled via communications with another communication device 106 (e.g., in-vehicle system 204 or fixed location system 304). In some implementations, the communication device 104 can be configured to provide periodic reporting to another communication device 106, the server 112, and/or any other devices or networks in order for these devices/networks to ascertain whether or not the communication device 104 and another communication device 106 are being continuously co-located. The reporting can be based on any desired period of time. If the communication device 104 fails to provide reporting after a predetermined period of time or stops providing reports, it may be determined that the device 104 is no longer co-located with the device 106. In some implementations, the devices receiving such reports from the device 104 may transmit a signal (e.g., a ping) to the device 104 to determine whether or not it is co-located with the device 106. Depending on the response received, location of the device 104 can be determined and based on that response, it can be determined whether or not devices 104 and 106 are co-located or not. Such signal transmission can be periodic at predetermined periods of time and/or after detecting that the communication device 104 has stopped or failed to report.

In some implementations, an RFID enabled communication device can allow for positive identification of a specific communication device 104 within a specified distance to the operators position. For example, an RFID tag can be attached to the communication device 104 to confirm location of the communication device 104 with respect to another communication device 106 (e.g., in-vehicle system 204 or fixed location system 304). This approach can include an operator implanting a RFID tag on the communication device 104, person or equipment of the operator. Once the tag is within a predetermined distance to the operator's position and the vehicle is powered up, another communication device 106 (e.g., in-vehicle system 204 or fixed location system 304) can scan the tag to recognize the operator. Another communication device 106 in conjunction with the database 114 can reconcile the operator and his/her communication device 104 as being associated with and in close proximity to a vehicle. In this manner, the communication device can be identified through association.

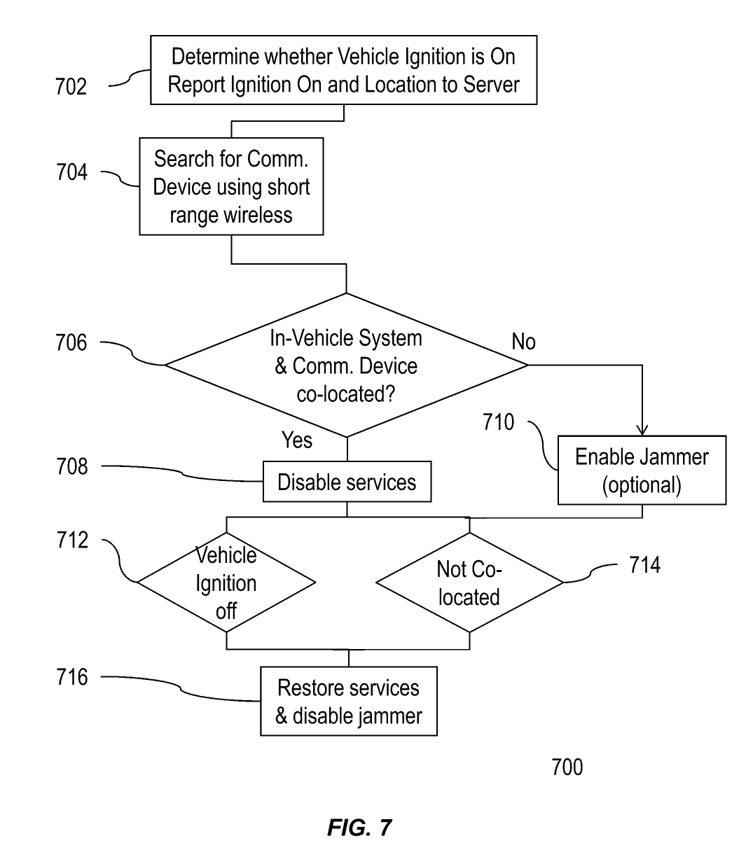

FIG. 7 illustrates an exemplary method 700 for operating a communication device, according to some implementations of the current subject matter. In particular, method 700 can be used to disable communication services in a vehicle having an in-vehicle system using short range wireless technology. At 702, the in-vehicle system determines whether or not vehicle's ignition has been turned on. Upon detection of the vehicle's ignition “on” status, the in-vehicle system can report the ignition “on” event and location of the vehicle (and thus, the in-vehicle system) to the server 112. At 704, upon receiving this information from the in-vehicle system, the in-vehicle system 204 or another communication device 106 can search for a short range wireless signal from any nearby portable communications devices. Short range wireless systems include but are not limited to Local Area Network devices like Wireless LAN, Bluetooth, Zigbee and other.

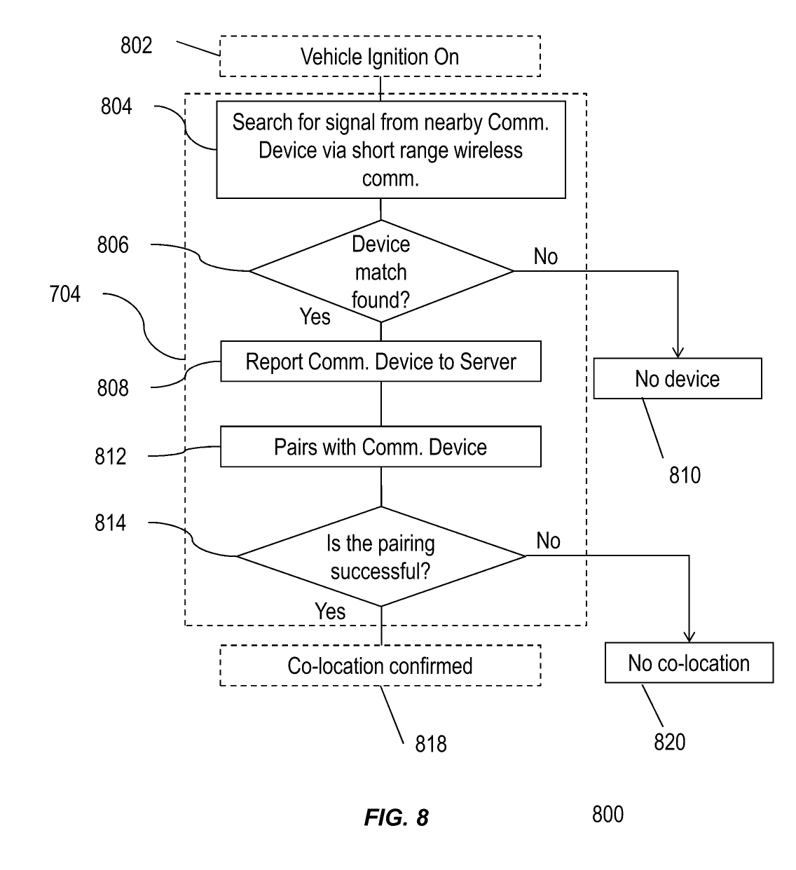

FIG. 8 illustrates further details of the searching for a short range wireless signal, as shown at 704. Upon determining that the vehicle's ignition is on, at 802, and the in-vehicle system 204 searching for a signal from nearby communication device via short range wireless communication, at 804, the determination is made whether or not matches are found, as shown at 806. If no match is found, the in-vehicle system 204 reports that no device is found, at 810. If a match is found, then the in-vehicle system 204 reports to the server 112 that a communication device has been detected and provides its identity to the server 112, at 808. At 812, the in-vehicle system 204 can be paired the detected communication device. At 814, a determination is made whether or not the pairing is successful. If not, then, at 820, the in-vehicle system 204 reports that no co-location was achieved. Otherwise, at 818, co-location is confirmed.

Referring back to FIG. 7, at 706, a determination is made whether or not the communication device 104 and another communication device 106 (e.g., in-vehicle system 204 or fixed location system 304) are co-located. If not or if no matching communication device is found, then at 710, a jamming device or a jammer, if any, can enabled, as discussed above. Otherwise, at 708, if co-location is confirmed, then at least one service to the communication device 104 can be disabled. As stated above with regard to FIGS. 5-6, services can be selectively disabled, (e.g., leaving 911-emergency calling intact).

At 716, disabled services of the communication device 104 can be restored and the jamming device disabled, if the vehicle's ignition is turned off, at 712, or, at 714, if the communication device 104 and another communication device 106 (e.g., in-vehicle system 204 or fixed location system 304) are no longer co-located. The “ignition off” event can be detected by another communication device 106 (e.g., in-vehicle system 204 or fixed location system 304) and reported to the server 112. Co-location of the communication device 104 and another communication device 106 (e.g., in-vehicle system 204 or fixed location system 304) can be periodically monitored by the server 112, e.g., by periodically requesting updated location information. Upon detecting that the communication device 104 and another communication device 106 are no longer co-located, the server 112 can enable service via communications with the application on the communications device 104, or via communications with the network 110. The jamming device can be disabled via communications with another communication device 106 (e.g., in-vehicle system 204 or fixed location system 304). In some implementations, loss of co-location can be determined by the loss of pairing between the in-vehicle system or another communication device and the communication device 104 over the short range wireless communications.

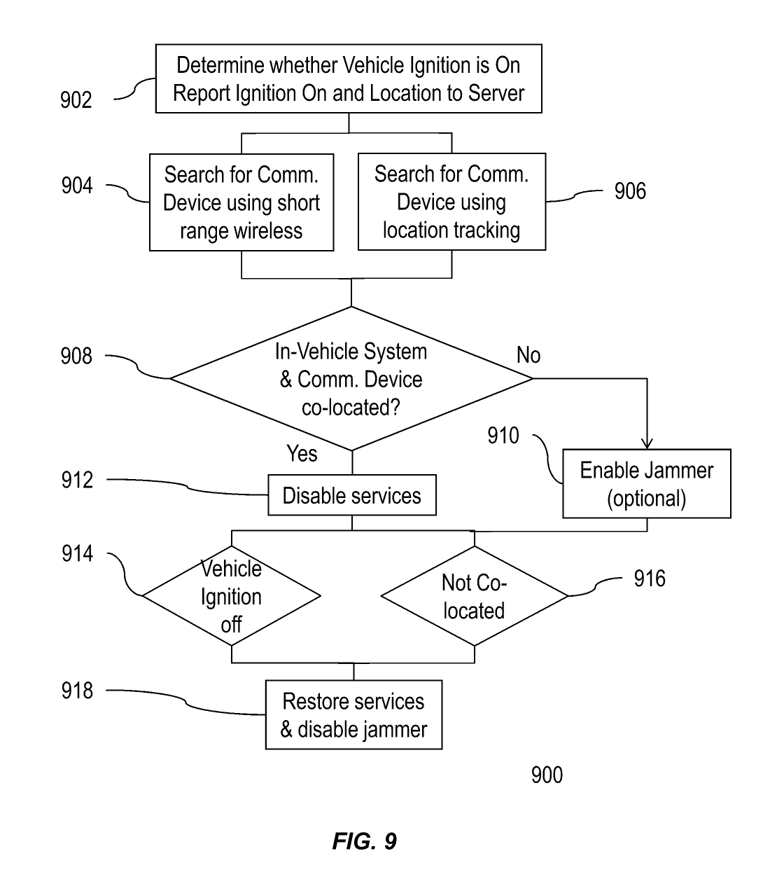

FIG. 9 illustrates another exemplary method 900 for operating a communication device 104, according to some implementations of the current subject matter. Method 900 can be implemented using location tracking searching and/or short range wireless signal techniques, which are discussed with respect to FIGS. 5-6 and 7-8, respectively.

At 902, the in-vehicle system determines whether or not vehicle's ignition has been turned on. Upon detection of the vehicle's ignition “on” status, the in-vehicle system can report the ignition “on” event and location of the vehicle (and thus, the in-vehicle system) to the server 112. At 904, upon receiving this information from the in-vehicle system, the in-vehicle system 204 or another communication device 106 can search for a short range wireless signal from any nearby portable communications devices. At 906, upon receiving this information from the in-vehicle system, the server 112 can search for a communication device 104 that can be carried by the user 102. As can be understood by one having ordinary skill in the relevant art, the searching can be performed using one or both techniques 904 and/or 906.

At 908, a determination is made whether or not the communication device 104 and another communication device 106 (e.g., in-vehicle system 204 or fixed location system 304) are co-located. If not or if no matching communication device is found, then at 910, a jamming device or a jammer, if any, can enabled, as discussed above. Otherwise, at 912, if co-location is confirmed, then at least one service to the communication device 104 can be disabled while other services remain operational.

At 918, disabled services of the communication device 104 can be restored and the jamming device disabled, if the vehicle's ignition is turned off, at 914, or, at 916, if the communication device 104 and another communication device 106 (e.g., in-vehicle system 204 or fixed location system 304) are no longer co-located.

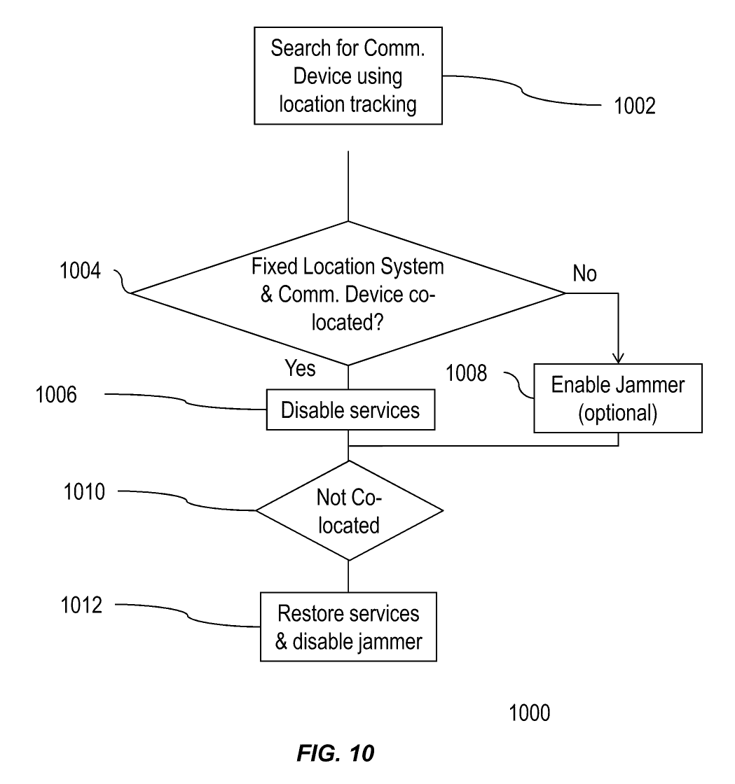

FIG. 10 illustrates an exemplary method 1000 for operating a communication device 104 in a fixed location system 304, according to some implementations of the current subject matter. The method 1000 is similar to the method 500 shown in FIG. 5 but as applied to the fixed location system 304. At 1002, the server 112 can search for a communication device 104 that can be carried by the user 102. The searching methodology can be similar to the one discussed with respect to FIG. 6 above. The searching can be initiated using a predetermined trigger (e.g., detection of a user turning on a computer; scheduled searching, time, specific location, physical conditions of the user or any other trigger). At 1004, a determination is made whether or not the communication device 104 and another communication device 106 (e.g., fixed location system 304) are co-located. If not or if no matching communication device is found, then at 1008, a jamming device or a jammer, if any, can enabled (similar to the one discussed above). At 1006, if co-location is confirmed, then at least one service to the communication device 104 can be disabled. At 1012, disabled services of the communication device 104 can be restored and the jamming device disabled, if, at 1010, it is determined that the communication device 104 and another communication device 106 (e.g., fixed location system 304) are no longer co-located. Such determination is discussed in connection with FIG. 5 above.

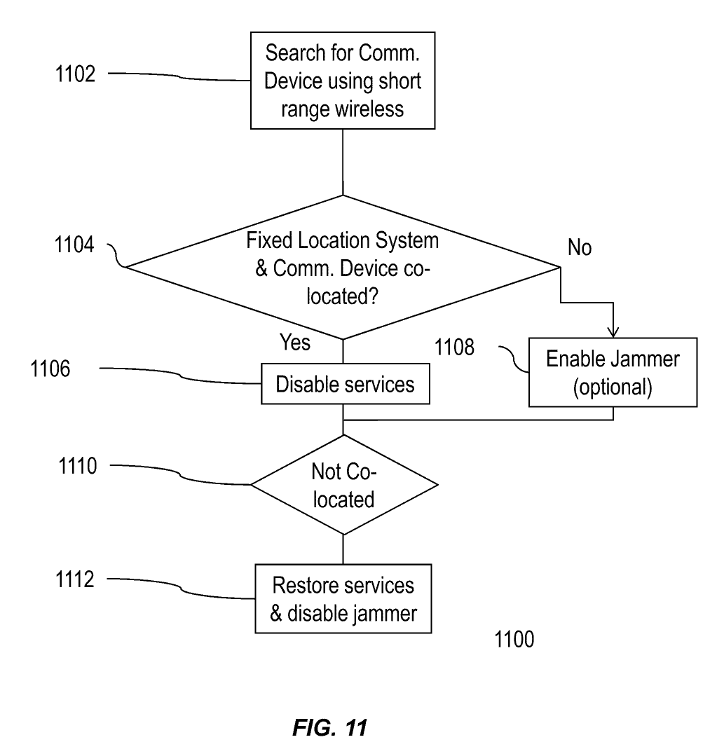

FIG. 11 illustrates an exemplary method 1100 for operating a communication device 104 in a fixed location system 304 using a short range wireless technique, according to some implementations of the current subject matter. At 1102, the system 304 or another communication device 106 can search for a short range wireless signal from any nearby portable communications devices. At 1104, a determination is made whether or not the communication device 104 and another communication device 106 (e.g., fixed location system 304) are co-located. If not or if no matching communication device is found, then at 1108, a jamming device or a jammer, if any, can enabled, as discussed above. At 1106, if co-location is confirmed, then at least one service to the communication device 104 can be disabled. As stated above with regard to FIGS. 7-8, services can be selectively disabled, (e.g., leaving 911-emergency calling intact). At 1110, disabled services of the communication device 104 can be restored and the jamming device disabled, if, at 714, the communication device 104 and another communication device 106 (e.g., fixed location system 304) are no longer co-located. As can be understood by one having ordinary skill in the relevant art, various triggering events can be used to determine searching and co-location information of the communication device 104 and another communication device 106. These can include, but are not limited, particular user(s), communication device(s), time of day, actions by the user(s) and/or device(s), actions by the devices that can be communicatively coupled to either the communication device 104, server 112, and/or another communication device 106. As can be understood by one having ordinary skill in the relevant art, there can be any number of triggers that activate the system, which include, but are not limited to, physical and/or emotional condition(s) of the user (e.g., whether the user is tired, anxious, under the influence of a substance, sleep-deprived, alert, etc.), environmental factors (e.g., atmospheric conditions, such as, current weather, rain, snow, sun, wind, temperature, presence of carbon monoxide, etc.), physical state(s) of the communication device and/or another communication device (e.g., location, time, and speed of movement, altitude, direction of movement, lighting, air quality, variation in time, speed, altitude, direction of movement, lighting, air quality, etc.) or any other factors. As can be understood by one having ordinary skill in the art, some implementations of the current subject matter can control operation of various devices and/or systems that can be part of the mobile and/or fixed (or any combination thereof) systems discussed above. Such control can be implemented based on the various triggers, conditions, states or any other factors or parameters relating to these systems and/or user(s) that are operating, controlling, or otherwise using such systems. For example, a driver of a vehicle may be prevented from turning on an ignition of a vehicle, if it is determined that the driver is in an inadequate state to operate such vehicle (e.g., under the influence of a substance). Such determination can be made based on driver's communication device (e.g., cellular telephone) being co-located with the vehicle, in-vehicle system and/or any other device/system disposed in the vehicle. In some implementations, the determination can be made using various sensory equipment (e.g., alcohol sensors, eyelid movement sensors, biometric sensors, etc.) that may be disposed in the vehicle or in any other location. In some implementations, various systems/devices that may be disposed in the vehicle may communicate with the communication device, the in-vehicle system, the server, and/or the network and/or a third party (e.g., a dispatcher, an operator, etc.) to affect operation of the driver's vehicle, and/or his/her communication device. As can be understood by one having ordinary skill in the relevant art, the current subject matter is not limited to the examples discussed above and can be applicable to any moving, fixed and/or hybrid systems as well as any communication devices and/or users.

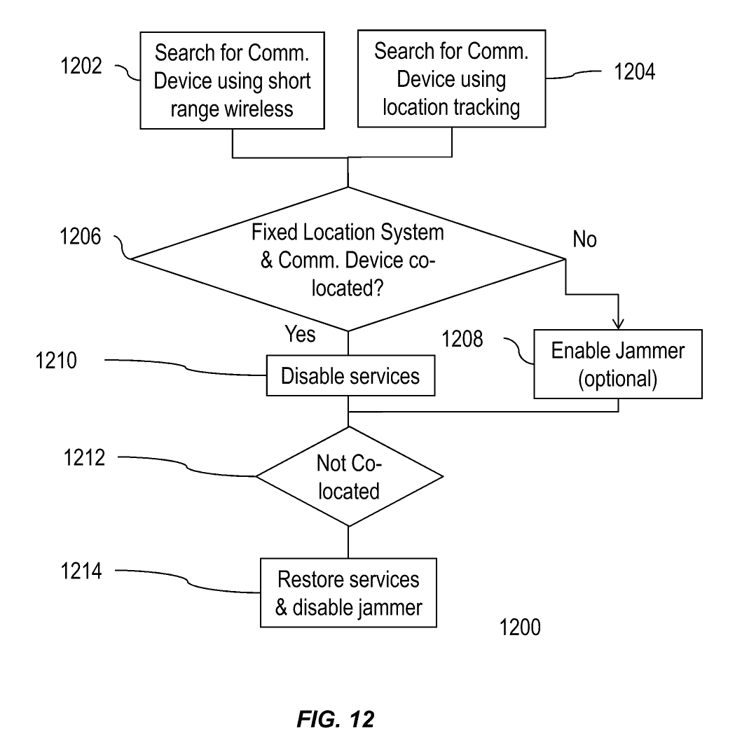

FIG. 12 illustrates another exemplary method 1200 for operating a communication device 104 in a fixed communication system using location tracking and short range wireless searching techniques, according to some implementations of the current subject matter. This method is similar to the one shown in FIG. 9, but as applied to the fixed location system. A search for a short range wireless signal from any nearby portable communications device(s), at 1202, and/or a search using a location tracking technique, at 1204 is/are performed. At 1206, a determination is made whether or not the communication device 104 and another communication device 106 (e.g., fixed location system 304) are co-located. If not or if no matching communication device is found, then at 1208, a jamming device or a jammer, if any, can enabled, as discussed above. At 1210, if co-location is confirmed, then at least one service to the communication device 104 can be disabled while other services can remain operational. At 1214, disabled services of the communication device 104 can be restored and the jamming device disabled, if at 1212, the communication device 104 and another communication device 106 (e.g., in-vehicle system 204 or fixed location system 304) are no longer co-located.

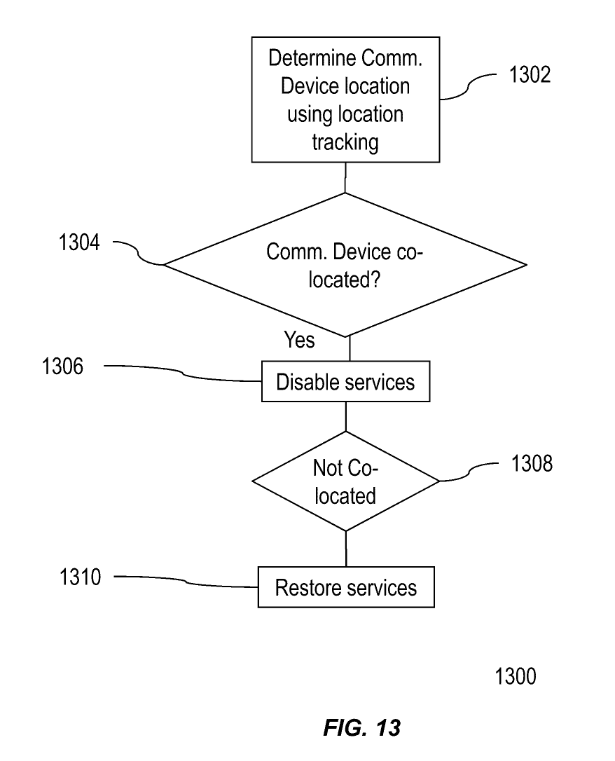

FIG. 13 illustrates an exemplary method 1300 for operating a communication device 104, according to some embodiments of the present invention. The method 1300 is useful when the communication device 104 is the only device available to provide location tracking, i.e., no other systems are available. In this case, the co-location range 108 can be based around a predetermined physical location, which is referred to as a geofence. At 1302, the communications device 104 determines its own location and reports that location to the server 112. At 1304, if the determined location of the communication device 104 is co-located with a predetermined physical location, then services can be disabled, at 1306. Otherwise, at 1308, if it is determined that the communication device 104 is no longer co-located with the predetermined physical location, then, at 1310, the services are restored. Co-location and service activation can be determined in the communication device 104 and/or in the server 112. Services can be selectively disabled and restored in the communication device 104 using a resident application or by the network 110.

Various features of the current subject matter can be achieved using one or more approaches. In some implementations, a device can be activated by turning on a vehicle and once functioning it will actively look for certain registered cellular devices. If a registered communication device is detected, a signal can be sent from a device installed in the vehicle or other area in which operation of the registered communication device is to be restricted. Alternatively, a signal can be propagated or sent through the registered communication device to the service provider or a dispatch service center to request a predetermined restricted use protocol.

A specific service, such as for example text messaging, access to the internet, voice calls, games, and the like, can in some implementations, be targeted and disabled while leaving one or more other capabilities of the communication device intact and fully operational. In some variations, some implementations of the current subject matter can include an ability to selectively turn off any of the other subscription options within the communication device. In this manner, the current subject matter can be used to actively enforce laws or regulations restricting the use of communication devices within a space or area, for example the driver's seat of a vehicle, during the conduct of official business. Similar restrictions can be enforced for an individual within the confines of their personal vehicle(s) based on preferences established by an owner or other person or entity with legal authority to control the use of a vehicle.

The current subject matter can in some implementations create the effect of interrupting or preventing one or more selected features of a communication device or the like through a vehicle installed system of components. These components can include, but are not restricted to, a GPS device, a Bluetooth or similar communications device, a RFID device, a cellular communications device, and or any other technology that facilitates determination that a communication device is located within a space or area where one or more services are to be restricted. A device, apparatus, or system consistent with various aspects of the current subject matter can interact with a communication device via an initial pairing process, which can also be referred to as a handshaking process, a mating process, or the like. During this pairing process, the communication device can be positively identified as a registered communication device and therefore subject to selective restriction. If it is not a registered communication device then there can be an alternative method of disabling the communication device, for example through jamming of cellular or other wireless communications altogether for a certain radius from the space or area of exclusion (for example the driver's seat). This restriction can remain in place until the communication device either moves away from the proximity of the space or area of exclusion or the vehicle is turned off. In either event, once a terminating act occurs, full services can then be restored to the communication device.

A method of disabling a specific capability of a communication device during a period in which its owner or user is or might be engaged with the responsibilities of driving or operating a vehicle can in some implementations include providing within the vehicle a system, device, apparatus, method, or the like that positively identifies the operations of that vehicle. The presence of a communication device within the operating vehicle can be detected. The capability or capabilities of the communication device that are selected for disabling by the current subject matter can be targeted and turned off during the time of operation of the vehicle and then eventually restored under appropriate conditions.

In some variations, the positive identification of an operating vehicle can be accomplished through the power up process of that vehicle. For example, a device or devices according to some implementations of the current subject matter can monitor the ignition switch, power button, or other aspects of a vehicle's electrical or power system such as various internal circuits that are energized when the vehicle is running. Under such a detected condition, the device or system within the vehicle can be powered up. Validation of movement can, in some implementations, be unnecessary for disabling services to a communication device because the act of being stopped in an idling vehicle (for example at a red light) can appear similar to being parked with the engine running. While these two situations can in some instances be indistinguishable to a device monitoring the ignition or power system of the vehicle, the dangers involved in a vehicle operator being distracted at a red light are substantially greater than those of being parked with the engine idling. For safety concerns, a communication device disabling system can continue to execute its restrictive protocol once the vehicle is powered up, regardless of whether the vehicle is in motion or stopped for any reason.

One manner in which the presence of a communication device within a vehicle can be identified is through the use of Bluetooth communications. An in-vehicle system can include a Bluetooth communications device which seeks out a communication device within a predetermined range of the driver position of the vehicle. The in-vehicle system can initiate communications with any passively identified communication devices within range and begin to seek out specific communication devices to match previously known data against the data gathered from the communications. Communication devices to be impacted by the disabling system and method can in some instances have been previously identified as belonging to operators within the fleet of vehicles or otherwise registered (for example, using a phone number or other identifier for the communication device) for a specific account; in the case of a personal family account. The method of identification can in some examples be through the unique phone number or Subscriber Identity Module (“SIM”) card serial number.

An RFID enabled communication device can allow for positive identification of a specific communication device within a specified distance to the operators position. In this example, an RFID tag can be attached to a communication device to confirm the location of the communication device to a particular vehicle. This approach can include an operator implanting a RFID tag on the communication device, person or equipment of the operator. Once the tag is within a predetermined distance to the operator's position and the vehicle is powered up, an in-vehicle system can scan the tag to recognize the operator. The in-vehicle system in conjunction with a known data base can reconcile the operator and his/her communication device as being associated with and in close proximity to a vehicle. In this manner, the communication device can be identified through association.

In some implementations, the presence of a communication device belonging to an employee or member of an organization or group can be detected using a GPS signal for both the vehicles and the communication device. The location of a communication device can also be determined using other methods, for example a received signal strength indication (“RSSI”) method, triangulation from one or more cellular towers, or the like. With the consent of the communication device owner or employee, member, etc., a location tracking signal from the communication device is monitored and correlated against one or more location tracking signals of the operating vehicle. During operating hours, if a communication device location tracking signal matches the location tracking signal of a vehicle in one or more of direction of travel, speed, and the like, then the communication device and vehicle are recorded as being mated. A request can be forwarded to a communication device service provider to have one or more services to the communication device suspended until the communication device and vehicle are detected as being separated. The detection of separation of the communication device and the vehicle can be performed by observing that the location tracking signals of the communication device and vehicle no longer coincide. A computer-implemented algorithm can be used to positively identify when merging and divergence of a communication device and vehicle has occurred due to movements of the tracking signals of the communication device and vehicle mirroring and diverging from each other, respectively.

In the case of detection of a communication device, regardless of the method of mating the communication device to a vehicle, in a case in which the queried communication device is not recognized nor registered, a back-up method of service disabling can be activated by the dispatcher of fleet vehicles, parents of new drivers, or other interested parties who wish to restrict communication device in a vehicle or other situation. A secondary method of denial can include jamming of an overall communication device signal (for example a cellular signal) within a certain radius of the driver position or other location where communication device usage is to be restricted. A low power jamming device can be activated manually or automatically, for example when the owner or custodian of the vehicle or restricted location selects a method of communication device usage restriction.

The current subject matter can provide additional features as an alternative or in addition to features such as disabling the text message and/or voice call capabilities of a communication device. If the disabling of communication device services is done at the communication device service provider, any specific subscription service provided by the communication device service provider can be designated for temporary suspension. In the case of text messaging, the disabling process can be administered, in some examples automatically, from within an Internet or other web based operation. Once a communication device is mated to a vehicle or location for service restriction or otherwise positively identified, an automated request for service suspension can be sent to the service provider. The service provider can then suspend one or more services provided to the communication device owner's account until notified otherwise or for a certain period of time, whichever is shorter. The current subject matter can also allow communications via a Bluetooth device. In some implementations, the in-vehicle system can utilize the target communication device to communicate with the service provider. In this manner, the communication device can be used to forward the request for suspension of one or more services when prompted by the in-vehicle system, for example via a Bluetooth device.

In some implementations, reactivation of the services can be performed in a manner similar to the disabling of services by communicating the request to the service provider. In some implementations, a separation of the communication device from the vehicle can be detected in one or more ways. For example, the system can continue to query the presence of the communication device. In the event that the presence or connection is lost then a request for services to be reactivated can be sent. In this scenario, the communication device location can diverge from the vehicle location while the vehicle is still powered up. Distance and/or secondary movement detection via monitoring of GPS or other location tracking signals can be sufficient to restrict use of the communication device while the vehicle is being operated.

In another example, when the vehicle is powered down, the act of shutting down the vehicle can result in the loss of signal from the in-vehicle system and this action can be registered in an Internet or web based or other monitoring system. When the in vehicle signal is lost then an automatic request for re-activation can be sent to the communication device service provider. This request can be matched against the last known communication device mated to the vehicle when it was powered up. Another possible method can be based on elapsed time since the one or more communication device services were suspended or, in another example, on the owner or custodian of the vehicle or other location where services are to be restricted. In one example, an owner or custodian can set a limitation as to the maximum time in which it requests suspension of services for the communication device. In some implementations, this option can be a back-up and can be overridden by receipt of information indicating the existence of a still actively mated communication device and vehicle. In some implementations, the default time frame can exceed the expected number of hours during which a vehicle is to be operated and can act as a default in the event that other means of restoring services to the communication device fail to request service re-activation.

The subject matter can also be employed without cooperation from or interaction with a communication device service provider. In one implementation, this situation can be treated similarly to the case of a communication device that is not recognized. In this example, the process of powering up the in vehicle device and communication device detection can remain the same. Disabling of communication device services can be accomplished through local jamming of one or more signals set to and/or from the communication device. In some variations, it can be advantageous to perform the jamming while leaving 911 phone capabilities un-jammed. An accident detection system, device, or feature can be included within or in communication with the in vehicle device. In the event of detection of an accident by the accident detection system, device, or feature, the system can automatically default to ceasing all communication device service denial functions. At this point the operator would be free to use all functions of the communication device.

The subject matter described herein can be embodied in systems, apparatus, methods, and/or articles depending on the desired configuration. In particular, various implementations of the subject matter described herein can be realized in digital electronic circuitry, integrated circuitry, specially designed application specific integrated circuits (ASICs), computer hardware, firmware, software, and/or combinations thereof. These various implementations can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (“PLDs”), used to provide machine instructions and/or data to a programmable processor, including a machine-readable medium that receives machine instructions as a machine-readable signal. The term “machine-readable signal” refers to any signal used to provide machine instructions and/or data to a programmable processor.

The subject matter described herein can be implemented in a computing system that includes a back-end component, such as for example a data server, or that includes a middleware component, such as for example an application server, or that includes a front-end component, such as for example a client computer having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flow depicted in the accompanying figures and/or described herein does not necessarily require the particular order shown, or sequential order, to achieve desirable results. Other implementations may be within the scope of the following claim.

What is claimed:

1. A computer-implemented method, comprising:
receiving a location information of a communication device;
based on the location information of the communication device, determining whether the communication device and another communication device are co-located; and
based on the determination, controlling operation of the communication device.

2. The method according to claim 1, wherein the location information includes information concerning a physical location of the communication device.

3. The method according to claim 1, wherein the location information includes a wireless signal generated by the communication device.

4. The method according to claim 1, wherein the controlling further comprises
selectively disabling at least one service provided by the communication device upon determining that the communication device and the another communication device are co-located; and
enabling all services provided by the communication device upon determining that the communication device and the another communication device are no longer co-located.

5. The method according to claim 4, wherein said controlling is performed by at least one of the another communication device and a third communication device, wherein the third communication device is not co-located with the another communication device.

6. The method according to claim 5, wherein the third communication device is configured to communicatively couple the communication device and a communication services provider for the communication device.

7. The method according to claim 5, wherein the controlling is performed upon detecting a triggering condition.

8. The method according to claim 7, wherein the triggering condition is selected from a group consisting of: physical and/or emotional condition(s) of a user of the communication device and/or the another communication device, environmental factors surrounding the communication device and/or the another communication device, and physical state(s) of the communication device and/or the another communication device.

9. The method according to claim 5, wherein the selective disabling is performed using a short range wireless signal configured to be communicated between the communication device and the another communication device.

10. The method according to claim 5, wherein the controlling is performed using an interface communicatively coupled to at least one of the another communication device and the third communication device.

11. The method according to claim 4, wherein the controlling further comprises
selectively enabling at least one capability of the at least one disabled service provided by the communication device.

12. The method according to claim 1, wherein the controlling is performed based on the physical location of the communication device.

13. The method according to claim 1, wherein the communication device and the another communication device are configured to be co-located when the communication device is located within a predetermined area surrounding the another communication device.

14. The method according to claim 1, wherein the controlling is performed based on a prior communication history between the communication device and the another communication device.

15. The method according to claim 1, wherein the controlling is performed for a predetermined period of time.

16. The method according to claim 1, wherein the another communication device is disposed at a fixed location.

17. The method according to claim 1, wherein the another communication device is disposed at a mobile location.

18. The method according to claim 1, wherein the determining further comprises
identifying all communication devices that are co-located with the another communication device.

19. A computer program product comprising a machine-readable medium storing instructions that, when executed by at least one processor, cause the at least one processor to perform operations comprising:
receiving a location information of the communication device;
based on the location information of the communication device, determining whether the communication device and another communication device are co-located; and
based on the determination, controlling operation of the communication device.

20. The computer program product according to claim 19, wherein the location information includes information concerning a physical location of the communication device.

21. The computer program product according to claim 19, wherein the location information includes a wireless signal generated by the communication device.

22. The computer program product according to claim 19, wherein the controlling further comprises
selectively disabling at least one service provided by the communication device upon determining that the communication device and the another communication device are co-located; and
enabling all services provided by the communication device upon determining that the communication device and the another communication device are no longer co-located.

23. The computer program product according to claim 22, wherein said controlling is performed by at least one of the another communication device and a third communication device, wherein the third communication device is not co-located with the another communication device.

24. The computer program product according to claim 23, wherein the third communication device is configured to communicatively couple the communication device and a communication services provider for the communication device.

25. The computer program product according to claim 23, wherein the controlling is performed upon detecting a triggering condition.

26. The computer program product according to claim 25, wherein the triggering condition is selected from a group consisting of: physical and/or emotional condition(s) of a user of the communication device and/or the another communication device, environmental factors surrounding the communication device and/or the another communication device, and physical state(s) of the communication device and/or the another communication device.

27. The computer program product according to claim 23, wherein the selective disabling is performed using a short range wireless signal configured to be communicated between the communication device and the another communication device.

28. The computer program product according to claim 23, wherein the controlling is performed using an interface communicatively coupled to at least one of the another communication device and the third communication device.

29. The computer program product according to claim 22, wherein the controlling further comprises
selectively enabling at least one capability of the at least one disabled service provided by the communication device.

30. The computer program product according to claim 19, wherein the controlling is performed based on the physical location of the communication device.

31. The computer program product according to claim 19, wherein the communication device and the another communication device are configured to be co-located when the communication device is located within a predetermined area surrounding the another communication device.

32. The computer program product according to claim 19, wherein the controlling is performed based on a prior communication history between the communication device and the another communication device.

33. The computer program product according to claim 19, wherein the controlling is performed for a predetermined period of time.

34. The computer program product according to claim 19, wherein the another communication device is disposed at a fixed location.

35. The computer program product according to claim 19, wherein the another communication device is disposed at a mobile location.

36. The computer program product according to claim 19, wherein the determining further comprises
identifying all communication devices that are co-located with the another communication device.

37. A system, comprising:
a communication device;
another communication device communicatively coupled to the communication device and configured to receiver a location information of the communication device;
a server configured to be communicatively coupled to the another communication device and provide communications between the communication device and a communication services provider for the communication device;
wherein at least one of the another communication device and the server is configured to determine whether the communication device and another communication device are co-located based on the location information of the communication device and control operation of the communication device based on the determination;
wherein at least one service provided by the communication device is configured to be selectively disabled upon determining that the communication device and the another communication device are co-located; and
wherein all services provided by the communication device are configured to be enabled upon determining that the communication device and the another communication device are no longer co-located.

38. The system according to claim 37, wherein the location information includes information concerning a physical location of the communication device.

39. The system according to claim 37, wherein the location information includes a wireless signal generated by the communication device.

40. The system according to claim 37, wherein the at least one of the another communication device and the server is configured to control operation of the communication device upon detecting a triggering condition.

41. The system according to claim 40, wherein the triggering condition is selected from a group consisting of: physical and/or emotional condition(s) of a user of the communication device and/or the another communication device, environmental factors surrounding the communication device and/or the another communication device, and physical state(s) of the communication device and/or the another communication device.

42. The system according to claim 40, wherein the controlling is performed using an interface communicatively coupled to at least one of the another communication device and the third communication device.

43. The system according to claim 37, wherein at least one capability of the at least one disabled service provided by the communication device is selectively enabled.

44. The system according to claim 37, wherein operation of the communication device is controlled based on the physical location of the communication device.

45. The system according to claim 37, wherein each of the communication device includes a wireless transmitter and the another communication device includes a wireless receiver, wherein at least one service of the communication device is configured to be selectively disabled based on the wireless receiver receiving a short range wireless signal from the wireless transmitter.

46. The system according to claim 37, wherein the communication device and the another communication device are configured to be co-located when the communication device is located within a predetermined area surrounding the another communication device.

47. The system according to claim 37, wherein the operation of the communication device is configured to be controlled based on a prior communication history between the communication device and the another communication device.

48. The system according to claim 37, wherein the operation of the communication device is configured to be controlled for a predetermined period of time.

49. The system according to claim 37, wherein the another communication device is disposed at a fixed location.

50. The system according to claim 37, wherein the another communication device is disposed at a mobile location.

51. The system according to claim 37, wherein the another communication device is configured to identify all communication devices that are co-located with the another communication device.

52. A system, comprising:
a memory;
a processor coupled to the memory and configured to
receive a location information of a communication device;
based on the location information of the communication device, determine whether the communication device and another communication device are co-located; and
based on the determination, control operation of the communication device.

53. The system according to claim 52, wherein the location information includes information concerning a physical location of the communication device.

54. The system according to claim 52, wherein the location information includes a wireless signal generated by the communication device.

55. The system according to claim 52, wherein the controlling further comprises
selectively disabling at least one service provided by the communication device upon determining that the communication device and the another communication device are co-located; and
enabling all services provided by the communication device upon determining that the communication device and the another communication device are no longer co-located.

56. The system according to claim 55, wherein the controlling is performed by at least one of the another communication device and a third communication device, wherein the third communication device is not co-located with the another communication device.

57. The system according to claim 56, wherein the third communication device is configured to communicatively couple the communication device and a communication services provider for the communication device.

58. The system according to claim 56, wherein the controlling is performed upon detecting a triggering condition.

59. The system according to claim 58, wherein the triggering condition is selected from a group consisting of: physical and/or emotional condition(s) of a user of the communication device and/or the another communication device, environmental factors surrounding the communication device and/or the another communication device, and physical state(s) of the communication device and/or the another communication device.

60. The system according to claim 56, wherein the selective disabling is performed using a short range wireless signal configured to be communicated between the communication device and the another communication device.

61. The system according to claim 56, wherein the controlling is performed using an interface communicatively coupled to at least one of the another communication device and the third communication device.

62. The system according to claim 55, wherein the controlling further comprises
selectively enabling at least one capability of the at least one disabled service provided by the communication device.

63. The system according to claim 52, wherein the controlling is performed based on the physical location of the communication device.

64. The system according to claim 52, wherein the communication device and the another communication device are configured to be co-located when the communication device is located within a predetermined area surrounding the another communication device.

65. The system according to claim 52, wherein the controlling is performed based on a prior communication history between the communication device and the another communication device.

66. The system according to claim 52, wherein the controlling is performed for a predetermined period of time.

67. The system according to claim 52, wherein the another communication device is disposed at a fixed location.

68. The system according to claim 52, wherein the another communication device is disposed at a mobile location.

69. The system according to claim 52, wherein the determining further comprises
identifying all communication devices that are co-located with the another communication device.
